(19) United States
(12) Patent Application Publication
(10) Pub. No.: US 2013/0002837 A1
(43) Pub. Date: Jan. 3, 2013

(54) DISPLAY CONTROL CIRCUIT AND PROJECTOR APPARATUS

(76) Inventor: Tomomi YUNO, Kanagawa (JP)

(21) Appl. No.: 13/530,332

(22) Filed: Jun. 22, 2012

(30) Foreign Application Priority Data
Jun. 30, 2011 (JP) 2011-145304

(51) Int. Cl. H04N 13/04; G06F 3/038

(52) U.S. Cl. 348/56; 345/204; 348/E13.04

(57) ABSTRACT

A display control circuit includes: a device drive unit writing left and right images alternately into a light modulation device in time division based on time-division display type stereoscopic image data including the left and right images; a shutter glass drive unit driving opening and closing of liquid crystal shutters in the shutter glasses; a light source drive unit maintaining the total sum of light source current to be constant over cycles when an opening and closing period of the liquid crystal shutters is taken as one cycle; and a control unit controlling the timing of opening and closing the liquid crystal shutters with respect to the shutter glass drive unit, the timing of writing the left and right images with respect to the device drive unit and the luminance level of the light source in the opening and closing period with respect to the light source drive unit.

### FIELD

The present disclosure relates to a display control circuit and a projector apparatus suitable for being used, for example, when displaying 3D images in a time division system.

### BACKGROUND

There exists a technique of generating stereoscopic images (hereinafter referred to as “3D images”) in which stereoscopic vision can be realized by a user by using images of the same object imaged by two cameras which are set so as to correspond to parallax between right and left eyes of the user. The images taken by the two cameras are referred to as a “left image” for the left eye and a “right image” for the right eye (hereinafter, the right image and the left image may be collectively referred to as “right and left images”).

As display devices whereby a user can view 3D images, there exist a 3D display device and a projector apparatus projecting images on a screen. These display devices display right and left images alternately in time division on a display surface, which are used by being combined with shutter glasses using liquid crystal shutters in right and left lenses. Hereinafter, a lens for the left eye is referred to as a “left lens”, a lens for the right eye is referred to as a “right lens”, and the right lens and the left lens may be collectively referred to as “right and left lenses”. Additionally, when the liquid crystal shutter is opened, the lens is opened, and when the liquid crystal shutter is closed, the lens is closed.

In a period during which image display of a liquid crystal panel provided in the projector apparatus is rewritten and a period during which image change is delayed due to response speed of the liquid crystal panel, crosstalk occurs, in which right and left images partially overlap. In order to prevent the overlapping of right and left images, the liquid crystal shutters provided on right and left lenses of the shutter glasses are closed in the rewrite period of right and left images to prevent light from reaching to both eyes of the user from the right and left lenses. Hereinafter, to open and close the liquid crystal shutters provided on right and left lenses may be referred to as “opening and closing of right and left lenses”. The aperture of lenses can be calculated by a glass aperture function which will be described later. The luminance of light transmitting through the lens can be found by the glass aperture function.

FIG. 9 shows an example of the timing of opening and closing right and left lenses and the timing of switching images displayed on the liquid crystal panel in related art.

In FIG. 9, the timing of switching right and left images displayed on the liquid crystal panel is shown in an upper row, and the timing of opening and closing right and left lenses is shown in a lower row. Here, “R” represents a right image, “L” represents a left image and numerals added to respective characters represent frame numbers of respective right and left images in characters written in respective rectangular frames.

In the liquid crystal panel provided in the projector apparatus, one frame is divided per 1/240 seconds and right and left images are alternately switched every two frames, therefore, the user can see any of right and left images when light from a light source is transmitted through the liquid crystal panel. The reason why right and left images are switched every two frames is that a period of time for two frames ( 1/120 seconds) is necessary for switching images completely as response of the liquid crystal panel is slow. As described above, crosstalk occurs at the timing when right and left images are switched. Accordingly, the liquid crystal shutters of the right and left lenses are closed in the first frame in which right and left images start to be switched in two frames in which each of right and left images is displayed. Then, the liquid crystal shutter of any of right and left lenses corresponding to a right or left image is opened in the next frame, thereby allowing light transmitted through the liquid crystal panel to reach to one eye of the user. As electric current supplied to the light source is constant in related art, light emitted by the light source reaches to the eye of the user only when the liquid crystal shutter of any of right and left lenses is opened. At this time, the user can recognize an image vividly when light reaching to the eye of the user is bright, therefore, a technique of projecting images by changing the intensity of light emitted by the light source has been known from the past.

In JP-A-2003-102030 (Patent Document 1), there is disclosed a technique of projecting color-separated light emitted from the light source in time division by changing the intensity of light according to the color switched by a color separation means.

### SUMMARY

Incidentally, a technique of projecting 3D images on a screen by using a projector applying, for example, an UHP lamp (ultrahigh pressure mercury lamp) as a light source with high luminance has been used. However, electric current for emitting light in the UHP lamp (hereinafter referred to as “light source current”) is constant and light emission is maintained in the same brightness, therefore, the light intensity of the image reaching to the eye of the user is limited when the liquid crystal shutter of the lens is closed. Accordingly, the luminance of 3D images reaching to eyes of the user is lower than 2D images to be projected with a fixed light intensity in a state where right and left lenses are constantly opened. Additionally, in order to realize 3D vision of images by applying the UHP lamp, the only method is to control a pattern of opening glasses, therefore, crosstalk occurring when switching between opening and closing of right and left lenses is conspicuous, which lowers the quality of 3D images.

In the shutter glasses used for the above display device, the liquid crystal shutters are closed in the rewrite period of right and left images, therefore, a period of time during which the liquid crystal shutter of each of right and left lenses is opened will be ½ or less with respect to a display period of 3D images. Accordingly, in the period during which the liquid crystal shutters of right and left lenses are closed, it is difficult to use light reaching to the shutter glasses and the user recognizes 3D images as dark images. On the other hand, it is necessary to make the light source used in the display device larger and higher in luminance than related-art light sources in order to allow the user to recognize 3D images as bright images, which increases power consumption of the light source.

In view of the above, it is desirable to suppress power consumption of the light source while increasing the luminance of right and left images displayed in time division so as to reach to eyes of the user.

An embodiment of the present disclosure is directed to a display control circuit including a device drive unit writing a left image and a right image alternately into a light modulation device in time division based on time-division display type stereoscopic image data including the left image for a left eye and the right image for a right eye.

The display control circuit also includes a shutter glass drive unit driving opening and closing of liquid crystal shutters in the shutter glasses. The shutter glass drive unit closes both liquid crystal shutters provided on lenses for the left eye and the right eye of the shutter glasses in a rewrite period during which the left image and the right image written into the light modulation device overlap each other. On the other hand, the shutter glass drive unit opens the liquid crystal shutter provided on the lens of the shutter glasses corresponding to the written image in a period during which any of the left image and right image is independently written.

The display control circuit also includes a light source drive unit maintaining the total sum of light source current to be constant over plural cycles when an opening and closing period of the liquid crystal shutters is taken as one cycle. The light source drive unit increases the light source current to be supplied to a light source emitting light transmitted through the light modulation device and projected on a screen in the period during which any of the liquid crystal shutters is opened and reduces the light source current in the period during which both liquid crystal shutters are closed.

The display control circuit also includes a control unit controlling the timing of opening and closing the liquid crystal shutters with respect to the shutter glass drive unit, controlling the timing of writing the left image and the right image with respect to the device drive unit and controlling the luminance level of the light source in the opening and closing period of the liquid crystal shutters with respect to the light source drive unit.

According to the above configuration, it is possible to reduce the luminance of the light source in the rewrite period during which the right and left images are displayed in an overlapped state and to increase the luminance of the light source in the period during which any of the left image and right image is independently written.

According to the embodiment of the present disclosure, the luminance of the light source is reduced as low as possible in the rewrite period during which the right and left images are displayed in the overlapped state and the luminance of the light source is increased as high as possible in the period during which any of the images is independently displayed when displaying right and left images alternately in time division. Accordingly, the user can recognize 3D images with high luminance from clear right and left images and power consumption of the light source can be suppressed to a degree equivalent to related-art light sources.

### BRIEF DESCRIPTION OF THE DRAWINGS

FIG. 1 is a block diagram showing an internal configuration example of a 3D display system according to an embodiment of the present disclosure;

FIG. 2 is a block diagram showing an internal configuration example of a projector apparatus according to the embodiment of the present disclosure;

FIGS. 3A to 3D are configuration views showing an operation example of the projector apparatus according to the embodiment of the present disclosure;

FIG. 4 is an explanatory diagram showing an example of the timing of opening and closing right and left lenses and the timing of switching images displayed on liquid crystal panels according to the embodiment of the present disclosure;

FIGS. 5A and 5B are explanatory charts showing examples of waveforms of a glass aperture function and a light-source current function according to the embodiment of the present disclosure;

FIG. 6 is an explanatory chart showing a processing example of suppressing the increase of light source current just before the opening or just after the closing of right and left lenses according to the embodiment of the present disclosure;

FIG. 7 is an explanatory chart showing an example of light source current values at the time of opening and closing right and left lenses according to the embodiment of the present disclosure;

FIGS. 8A to 8C are explanatory charts showing a relation between the glass aperture function of the shutter glasses and light-source current values according to the embodiment of the present disclosure; and

FIG. 9 is an explanatory diagram showing an example of the timing of opening and closing right and left lenses and the timing of switching images displayed on the liquid crystal panel in related art.

### DETAILED DESCRIPTION

Hereinafter, modes for carrying out the present disclosure (hereinafter referred to as an embodiment) will be explained. The explanation will be made in the following order.

1. Embodiment (Control of Light Source Luminance: Example of increasing light source current in a stepwise manner according to the opening of a lens)

2. Modification Embodiment

### 1. Embodiment

### [Example of Increasing Light Source Current in a Stepwise Manner According to the Opening of a Lens]

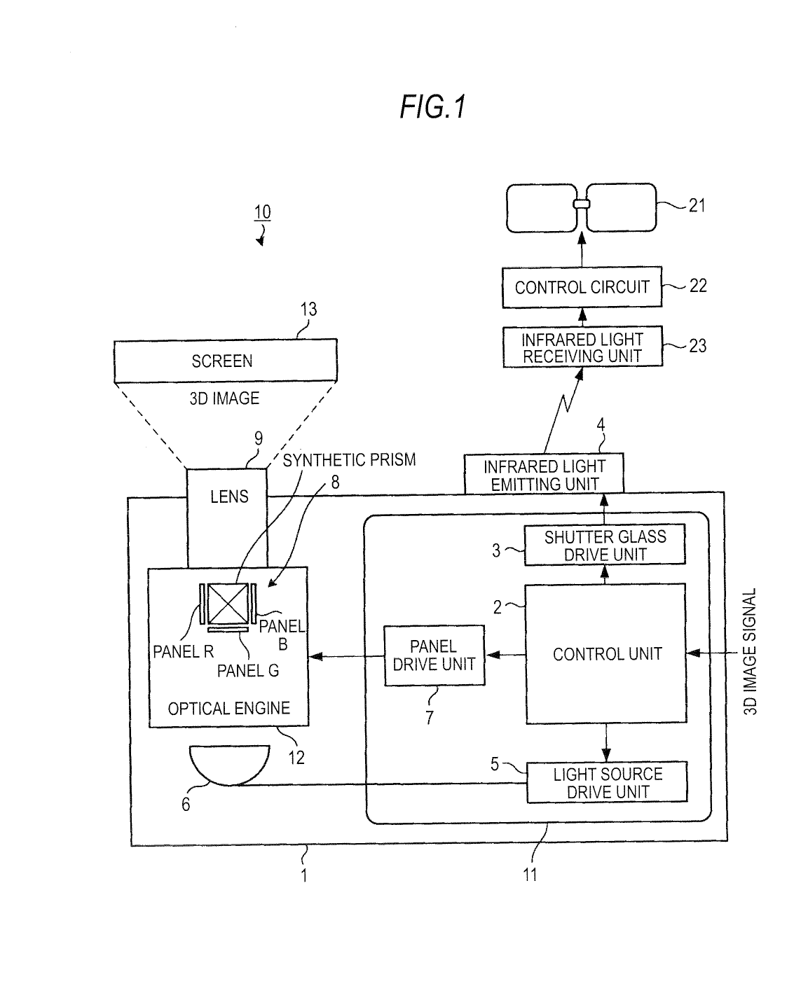

Hereinafter, an embodiment of the present disclosure will be explained with reference to FIG. 1 to FIGS. 8A to 8C. In the present embodiment, an example (hereinafter referred to as a “present example”) will be explained, in which the present disclosure is applied to a 3D display system 10 including a projector apparatus 1 projecting right and left images alternately in time division on a screen 13 and shutter glasses 21.

FIG. 1 shows an internal configuration example of the 3D display system 10.

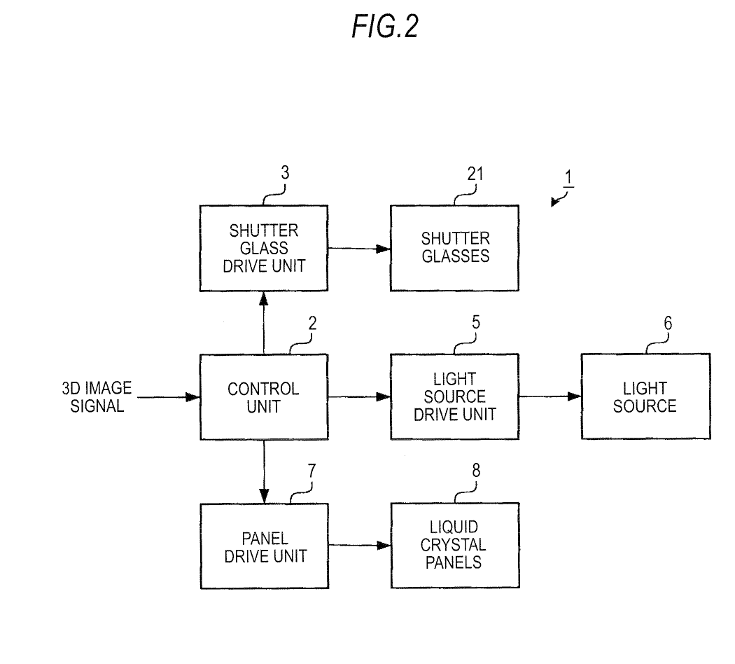

FIG. 2 shows an internal configuration example of the projector apparatus 1.

The 3D display system 10 includes the projector apparatus 1 projecting right and left images (3D images) on the screen 13 and the shutter glasses 21 in which liquid crystal shutters of right and left lenses are opened and closed in time division.

The projector apparatus 1 includes a display control circuit 11 controlling display of right and left images, an infrared light emitting unit 4 emitting infrared light to the shutter glasses 21 and a light source 6 emitting light to be projected on the screen 13 while changing the luminance under control of the display control circuit 11. The projector apparatus 1 also includes an optical engine 12 irradiating light emitted by the light source 6 as 3D image light. The optical engine 12 includes liquid crystal panels 8 as light modulation devices in which right and left images are alternately written in time division under control of the display control circuit 11 (a panel control unit 7) and a lens 9 magnifying images formed by light transmitted through the liquid crystal panels 8 with a given magnification and projecting the images on the screen 13.

The light source 6 emits light in a constant cycle (for example, 50 Hz). The light emitted by the light source 6 is transmitted through the liquid crystal panels 8 and projected on the screen 13 as 3D images. The optical engine 12 including the liquid crystal panels 8 and a synthetic prism projects light emitted by the light source 6 on the screen 13 through the liquid crystal panels 8 of R, G and B provided on the synthetic prism as image light of three primary colors under control of the display control circuit 11.

The display control circuit 11 includes a control unit 2 controlling output of a 3D image signal inputted from an external image reproduction apparatus (not shown). The display control circuit 11 also includes a shutter glass drive unit 3 outputting a shutter drive signal instructing the drive of liquid crystal shutters of right and left lenses of the shutter glasses 21 so as to correspond to right and left images switched in time division. The display control circuit 11 further includes a light source drive unit 5 controlling the luminance level of the light source 6 emitting light to be transmitted through the liquid crystal panels 8 by receiving an instruction from the control unit 2 and a panel drive unit driving the liquid crystal panels 8 by receiving an instruction from the control unit 7.

The light source drive unit 5 increases light source current supplied to the light source 6 emitting light transmitted through the liquid crystal panels 8 and projected on the screen 13 in a period when any of the liquid crystal shutters is opened when an opening and closing period of the liquid crystal shutters is taken one cycle. The light source drive unit 5 reduces light source current in a period when both liquid crystal shutters are closed. Then, control is performed so that the total sum of the light source current is constant over plural cycles.

The panel drive unit 7 is used as a device drive unit for driving light modulation devices (liquid crystal panels 8 in the example). The panel drive unit 7 alternately writes right and left images in time division on the liquid crystal panels 8 based on time-division display type stereoscopic image data (3D image signal) including the left image for the left eye and the right image for the right eye.

The control unit 2 controls the timing of opening and closing the liquid crystal shutters with respect to the shutter glass drive unit 3, controls the timing of writing the left image and the right image with respect to the panel drive unit 7 and controls the luminance level of the light source 6 in the opening and closing period of the liquid crystal shutters with respect to the light source drive unit 5. In a rewrite period of the right and left images with respect to the liquid crystal panels 8, the control unit 2 controls the light source drive unit 5 to reduce the luminance of the light source 6. Whereas in the period in which any of the right and left images is independently written into the liquid crystal panels 8, the control unit 2 controls the light source drive unit 5 to increase the luminance of the light source 6.

The shutter glass drive unit 3 supplies the shutter drive signal for driving liquid crystal shutters of the shutter glasses 21 to the infrared light emitting unit 4. The infrared light emitting unit 4 performs infrared transmission of the shutter drive signal to the shutter glasses 21. The shutter glass drive unit 3 also closes both liquid crystal shutters provided on lenses for the right eye and the left eye of the shutter glasses 21 in the rewrite period during which the left image and the right image which are written into the liquid crystal panels 8 overlap each other. On the other hand, the shutter glass drive unit 3 drives opening and closing of the liquid crystal shutters of the shutter glasses 21 so that the liquid crystal shutter provided on the lens of the shutter glasses 21 corresponding to the written image is opened in the period during which any of right and left images is independently written. Then, the infrared light emitting unit 4 performs current-to-light conversion of the shutter drive signal into an infrared signal, emitting light in a given pattern and transmitting the infrared signal to the shutter glasses 21.

The shutter glasses 21 includes an infrared light receiving unit 23 performs light-to-current conversion of the infrared signal received from the infrared light emitting unit 4 into the shutter drive signal and a control circuit 22 controlling the timing of opening and closing the right and left lenses of the shutter glasses 21 independently in accordance with the shutter drive signal. The shutter glasses 21 open the liquid crystal shutter of the left lens and close the liquid crystal shutter of the right lens when the user views the left image. On the other hand, the shutter glasses 21 open the liquid crystal shutter of the right lens and close the liquid crystal shutter of the left lens when the user views the right image. As right and left images switched in a short time are alternately inputted to right and left eyes of the user, the user can recognize the images as 3D images.

The projector apparatus 1 uses transmissive or reflective liquid crystal panels 8 as light modulation devices modulating image light of right and left images based on the 3D image signal, magnifying images transmitted through the light modulation devices by the lens 9 and projecting the images on the screen 13 by an optical system irradiating light from the light source on the light modulation devices. At this time, the projector apparatus 1 displays 3D images on the screen 13 in a time division system, increasing the luminance of images obtained in the case where any of right and left images is independently projected on the screen 13 by controlling the luminance of the light source.

The 3D image signal including right and left images is inputted to the control unit 2. The control unit 2 writes right and left images alternately into the liquid crystal panels 8 through the panel drive unit 7. At this time, the control unit 2 performs the following control of the light source current with respect to the light source drive unit 5 within a range between an upper limit and a lower limit of light source current allowed by the light source 6. That is, when the liquid crystal shutters of lenses of the shutter glasses 21 are opened, the control unit 2 gives an instruction of increasing the light source current supplied to the light source 6 to the upper limit in a stepwise manner. When the liquid crystal shutters of lenses are closed, the control unit 2 gives an instruction of reducing the light source current supplied to the light source 6 to the lower limit. Accordingly, the control unit 2 performs control of opening and closing right and left lenses of the shutter glasses 21 through the shutter glass drive unit 3 so as to correspond to the timing when right and left images are written into the liquid crystal panels 8. At the same time, the control unit 2 allows the light source drive unit 5 to control the luminance of the light source 6 by transmitting a luminance control signal controlling the luminance level to the light source drive unit 5. As described above, the control unit 2 can control the luminance level of the light source 6 and the timing of switching the liquid crystal shutters of the shutter glasses 21 so as to correspond to the timing of switching right and left images displayed in time division.

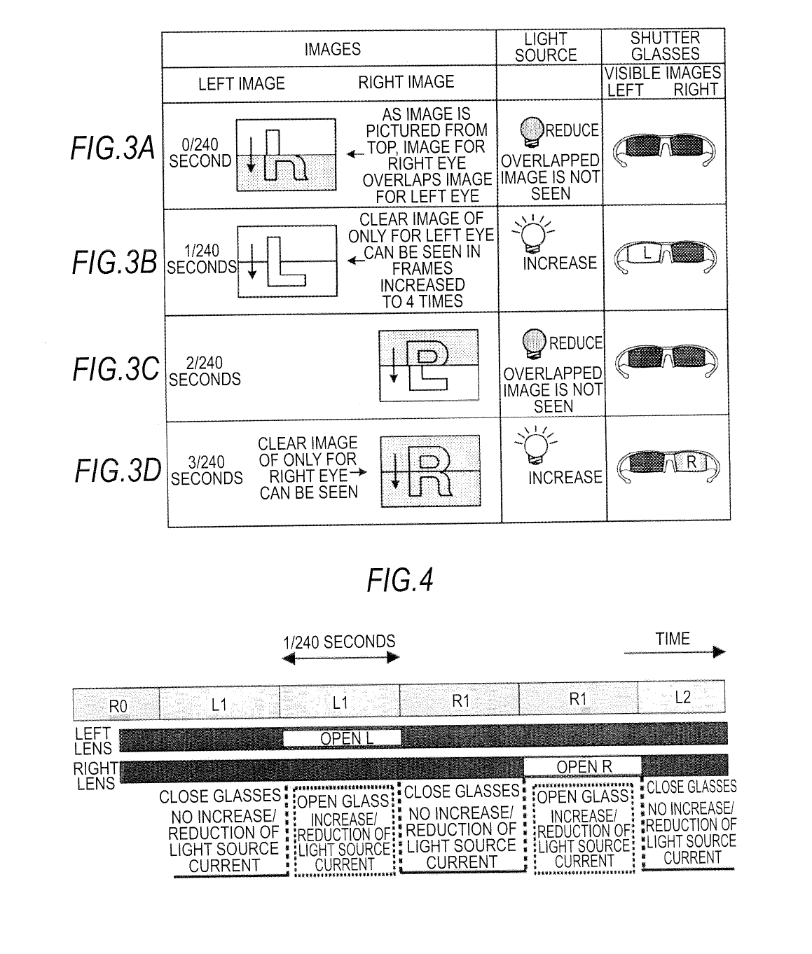

FIGS. 3A to 3D show an operation example performed when the projector apparatus 1 displays 3D images including right and left images in time division per 1/240 seconds.

The projector apparatus 1 normally writes right and left images at 60 frames per a second respectively, namely, at 120 frames in total. However, right and left images are not rewritten in a moment at the switching timing but rewritten while right and left images are mixed, for example, from the upper left to the lower right of a screen. Therefore, crosstalk in which right and left images overlap each other is liable to occur when right and left images are switched. In the projector apparatus 1 according to the embodiment, right and left images are reproduced at 120 frames respectively (240 frames in total) which is double the frames of the normal device and 1/240 seconds are allocated to a write period of right and left images to control the luminance level of the light source 6 frame by frame, thereby displaying vivid 3D images.

FIG. 3A shows an example of an initial state (0/240 second) in the middle of writing left images over right images.

As the left image is written from the top at this time, the left image overlaps the right image already displayed in the write period. In this case, in order to prevent the user from viewing the image in the overlapped state, the luminance of the light source 6 is reduced in a moment and the liquid crystal shutters of right and left lenses of the shutter glasses 21 are closed. Accordingly, light reaching to both eyes of the user is shielded.

FIG. 3B shows an example of a state in which 1/240 seconds have passed since the initial state.

As the image is displayed at 240 frames per second, the left image is clearly displayed when 1/240 seconds have passed since the initial state as compared with the normal images displayed at 60 frames/second. As the luminance of the light source 6 is increased and light is transmitted through the left lens of the shutter glasses 21 at this time, the user can recognize the left image with high luminance.

FIG. 3C shows an example of a state in which 2/240 seconds have passed since the initial state.

As the right image is written from the top as described above, the right image overlaps the left image already displayed in the write period. In this case, in order to prevent the user from viewing the image in the overlapped state, the luminance of the light source 6 is reduced and the liquid crystal shutters of right and left lenses of the shutter glasses 21 are closed, thereby shielding light reaching to both eyes of the user.

FIG. 3D shows an example of a state in which 3/240 seconds have passed since the initial state.

The right image is clearly displayed when 3/240 seconds have passed since the initial state. As the luminance of the light source 6 is increased and light is transmitted through the lens for the right eye of the shutter glasses 21 at this time, the user can recognize the right image with high luminance.

FIG. 4 shows an example of the timing of opening and closing liquid crystal shutters of right and left lenses of the shutter glasses 21 and the timing of switching images displayed on the liquid crystal panels 8.

In FIG. 4, the timing of switching images displayed on the liquid crystal panels 8, which are switched as time passes, is shown in an upper row, and the timing of opening and closing the liquid crystal shutters of right and left lenses of the shutter glasses 21 is shown in a lower row. Here, “R” represents a right image, “L” represents a left image and numerals added to respective characters represent frame numbers of respective images in characters written in respective rectangular frames.

As the operation example of the liquid crystal panels 8 driven by the panel drive unit 7 is the same as the related-art operation example of the liquid crystal panels, the explanation is omitted (see FIG. 9)

It is necessary to display the right image and the left image alternately for displaying bright 3D images on the screen 13. In order to allow the right image to reach only to the right eye and allow the left image to reach only to the left eye, the shutter glasses 21 are used, which can control light transmission or shielding in synchronization with right and left images alternately rewritten. As described above, the liquid crystal shutter of the left lens of the shutter glasses is opened and the liquid crystal shutter for the right eye is closed during the display period of the left image. Next, the liquid crystal shutter of the left lens of the shutter glasses is closed and the liquid crystal shutter of the right lens is opened at the same time as the right image is displayed. After that, the liquid crystal panels 8 and the shutter glasses 21 repeat the operation.

The right and left images projected by the projector 1 are displayed while being switched alternately at a given timing. Accordingly, it is ideally desirable that the liquid crystal shutter of the lens for the right eye is closed when the left image is displayed, and the liquid crystal shutter of the left lens of the shutter glasses 21 is closed when the right image is displayed.

However, when the projector apparatus 1 performs display while switching from the right image to the left image, the left image is written from the top toward the bottom of the screen. Here, when the user views the right image and the left image at the same time, the right and left images are seen in the overlapped state. As a result, not only images seen by the user have a vague outline but also stereoscopic effect in the images is reduced, therefore, it is necessary to avoid the state in which right and left images are viewed at the same time. However, if the light source 6 is completely turned off, it takes time when the light source 6 is turned on again, therefore, it is desirable to reduce the luminance of the light source 6 as close to turned off as possible.

Accordingly, the light drive unit 5 performs control so as to increase the luminance by increasing light source current supplied to the light source 6 by the light source drive unit 5 at the timing of opening the liquid crystal shutter of any of the right and left lenses and so as to reduce the luminance by reducing light source current at the timing of closing the liquid crystal shutter of both right and left lenses.

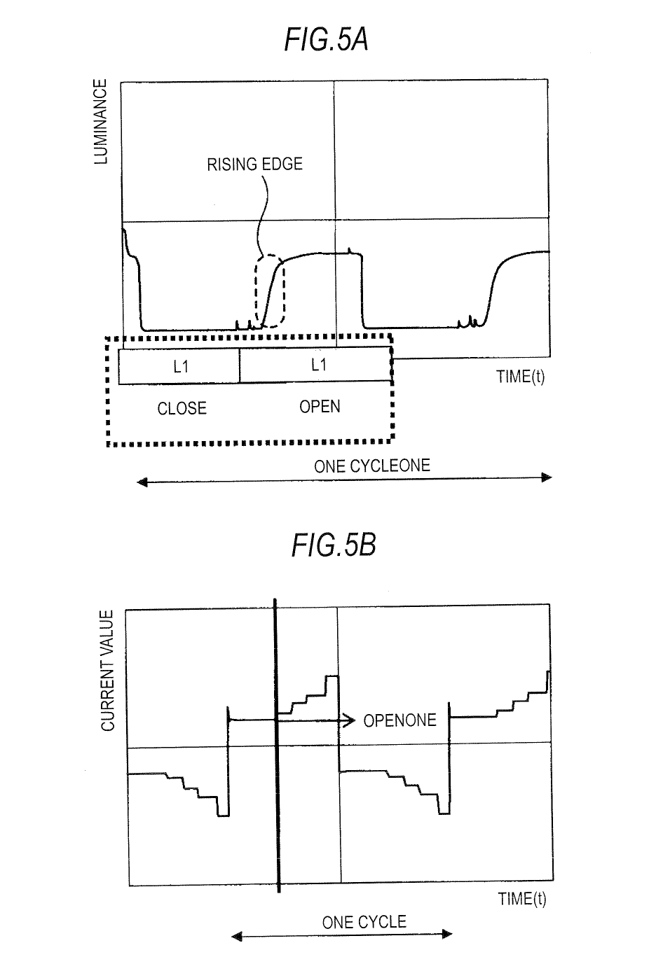

FIGS. 5A and 5B show examples of waveforms of a glass aperture function and a light-source current function. FIG. 5A shows an example of showing the glass aperture function in a graph and FIG. 5B shows an example of showing the light-source current function in a graph.

The glass aperture function is a function for calculating the aperture of the shutter glasses 21. In FIG. 5A, values calculated by measuring luminance of light transmitted through the liquid crystal shutter by a luminance meter obtained when opening and closing the liquid crystal shutters of the shutter glasses 21 put in front of the light source having a constant luminance are plotted, which are shown in the graph by taking luminance in the vertical axis and by taking time in the horizontal axis. Effects of pulses due to disturbance are removed in the glass aperture function. The glass aperture function shown in FIG. 5A is not a rectangular wave and it is found that the pulse is gradually increased in a transition period when the liquid crystal shutter of the lens is opened. In a period of a rising edge shown in FIG. 5A, the control is performed so that light source current is not increased or light source current is intentionally reduced for avoiding the reduction in image quality due to effects of crosstalk with respect to response characteristics of liquid crystal shutters of the shutter glasses 21.

The light-source current function is a function of calculating the intensity of the light source supplied to the light source 6. In FIG. 5B, light-source current values obtained by increasing light source current in a stepwise manner so as to correspond to the aperture of the lens are plotted, which are shown in the graph by taking current values in the vertical axis and by taking time in the horizontal axis.

Here, the light source drive unit 5 increases the luminance of the light source 6 after the response time of the liquid crystal panels 8 passes at the time of rewriting the right image or the left image.

It has been found that it is necessary to increase light source current in a stepwise manner for increasing light source current effectively at the time of opening the lens. It is because a lamp voltage applied to the light source 6 is drastically increased in a short time, which may affect the lifetime of the light source 6, in order to increase the light source current by using other methods than the method of increasing light source current in a stepwise manner. Accordingly, the control is performed so that light source current is reduced when the lens is closed and light source current is gradually increased when the lens is opened. Specifically, the light source drive unit 5 reduces light source current in a first ¼ cycle (for 1/240 seconds) and increases light source current a subsequent ¼ cycle (for 1/240 seconds)

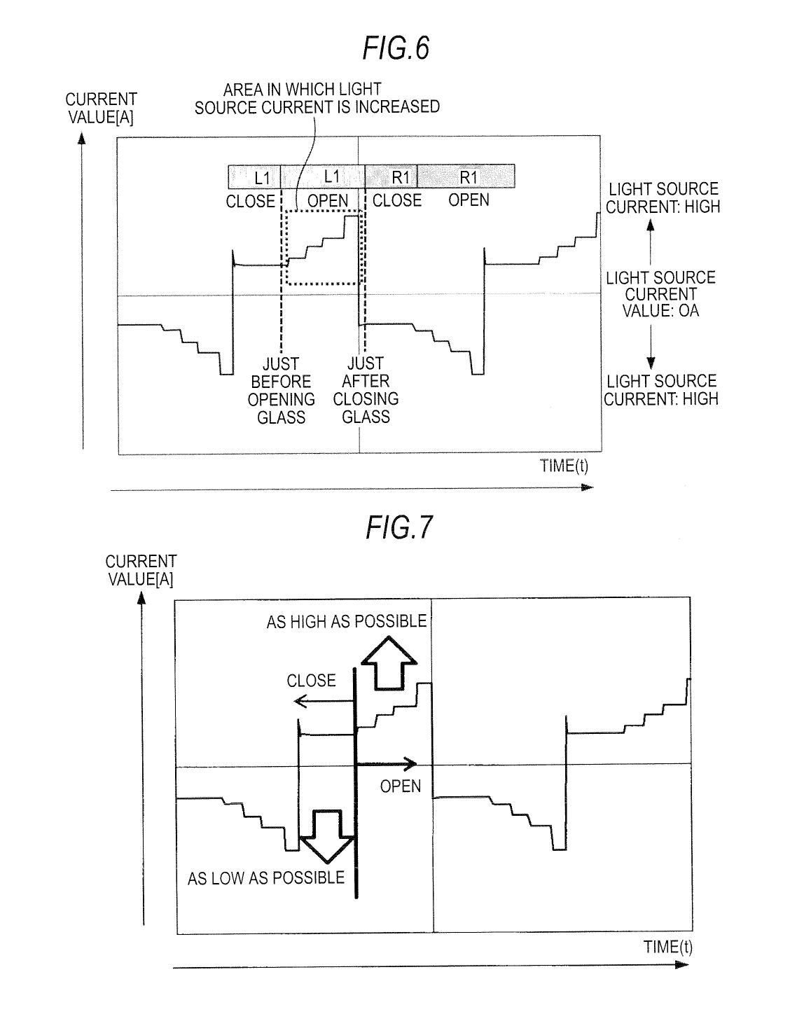

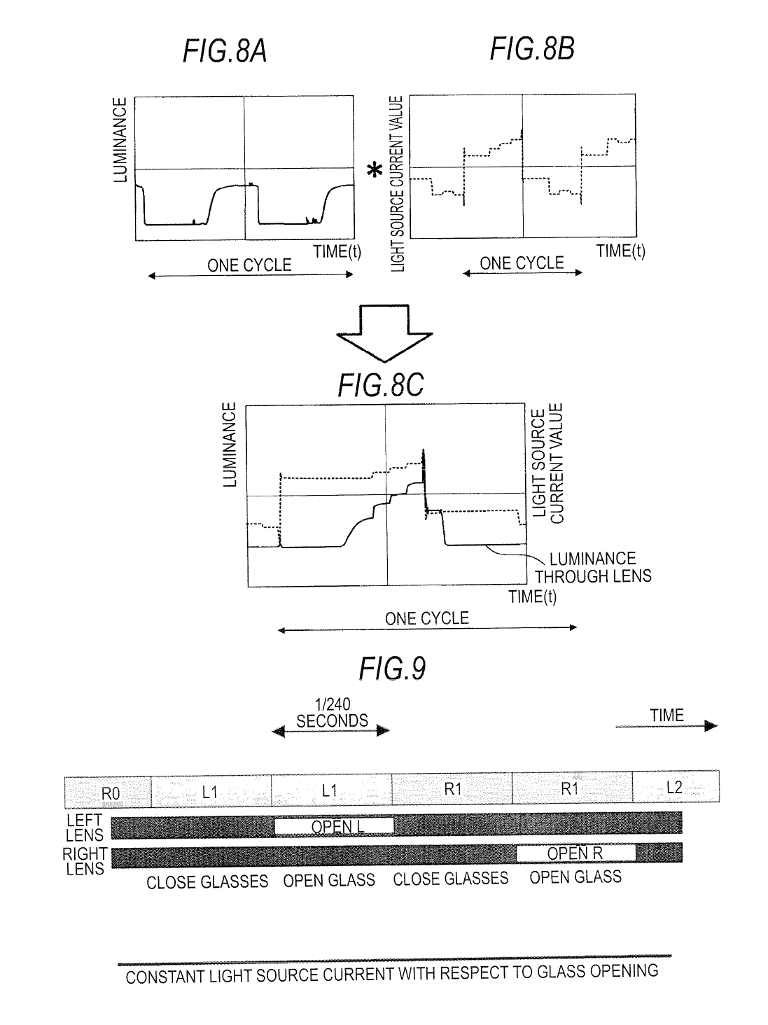

FIG. 6 shows a processing example of suppressing the increase of light source current just before the opening or just after the closing of right and left lenses.

As described above, opening and closing of right and left lenses are switched every 1/120 seconds so as to correspond to the timing of switching right and left images. At this time, the liquid crystal shutters of both right and left lenses are closed for the first 1/240 seconds when the image is start to be switched, and the liquid crystal shutter of any of right and left lenses is opened for the subsequent 1/240 seconds.

Even in a period just after any of right and left lenses is opened, the light source drive unit 5 does not increase light source current for suppressing effects of crosstalk. There exists a period when both right and left lenses are opened before any of right and left lenses is opened. However, as the drive speed of liquid crystal is slow, when both right and left lenses are opened at the time of displaying any of right and left images is displayed, crosstalk occurs. In order to avoid the occurrence of crosstalk, the light source drive unit 5 suppresses the increase of light source current supplied to the light source 6 just before the shutter glass drive unit 3 opens the liquid crystal shutter as well as just after the shutter glass drive unit 3 closes the liquid crystal shutter. After that, the light source current is increased with time lapse when the liquid crystal shutter is opened. The reason of the operation is that right and left lenses are not opened by the rectangular wave in a moment but are gradually opened, and it is optimum that light source current is increased according to the aperture.

FIG. 7 shows an example of light source current values at the time of opening and closing right and left lenses.

When right and left lenses are closed, a waveform of light source current can be arbitrary. However, it is necessary to increase the light source current value as high as possible at the time of opening right and left lenses and reduce the light source current value as low as possible at the time of closing right and left lenses in order to increase the luminance of 3D images while maintaining power consumption of the light source 6 to be constant. Here, at the time of controlling the increase of light source current in a given time domain, the power consumption of the light source 6 have to be constant when observing the current in a certain period of time over plural frame periods. Accordingly, the light source current value at the time of opening/closing of right and left lenses is fixed as the following expression (1).

The light source current value at the time of closing right and left lenses+the light source current value at the time of opening right and left lenses=constant (1)

In this case, it is desirable that a relation of the light source current value at the time of closing right and left lenses<<the light source current value at the time of opening right and left lenses” is satisfied.

FIGS. 8A to 8C show a relation between the glass aperture function of the shutter glasses 21 and light source current values.

FIG. 8A shows an example of the glass aperture function.

As described above, opening or closing of right and left lenses of the shutter glasses 21 is controlled by opening and closing the liquid crystal shutters, therefore, it takes time until the lenses are opened.

FIG. 8B shows an example of a waveform of the light source current values.

The light source drive unit 5 increases the light source current value in a stepwise manner when the liquid crystal shutter of the shutter glasses 21 is opened, thereby supplying current as high as possible to the light source 6. Then, the light source drive unit 5 supplies current as low as possible to the light source 6 when the liquid crystal shutter is closed.

FIG. 8C shows an example of luminance measured when light from the light source 6 is transmitted through the shutter glasses 21.

A mountain-shaped waveform represented by the glass aperture function varies according to the luminance represented by the waveform of light source current. It is found that the luminance obtained by measuring light transmitted through the shutter glasses 21 varies in a stepwise manner from the waveform of the luminance shown in FIG. 8C. The light source current is gradually increased in accordance with the time during which the glasses are opened as described above, thereby increasing the brightness of 3D images seen through the shutter glasses 21 by the user in a stepwise manner.

At this time, the ideal function is represented by the following expression (2)

The glass aperture function×the waveform of light source current supplied when right or left lens is opened=Maximum value (2)

The control unit 2 performs calculation with respect to the glass aperture function f(t) and the light-source current function g(t) by using the following expression (3). In this case, the light source drive unit 5 monotonically increases a time integral value of light source current in the period during which the liquid crystal shutter is opened, determining g(t) so that the time integral value becomes maximum. Note that f(t) is the function uniquely determined according to the type of the shutter glasses 21.

(f*g)(t)=∫f(τ)g(t−τ)dτ (3)

As f(t) and g(t) are periodic functions, sequence calculation is performed as shown in the following expression (4).

$$( f * g ) ( m ) = {\sum }_{n} f ( n ) g ( m - n ) \qquad ( 4 )$$

It is desirable that the glass aperture function f(t) is defined as constant multiplication of the current function. Accordingly, g(t) in which convolution corresponding to the above expression can be represented by the following expression (5). Here, “k” denotes a constant and ∞ denotes similarity.

f(t)∞k×g(t) (5)

In the above-explained 3D display system 10 according to the embodiment, when 3D images are displayed by projecting 3D images in the time division system on the screen 13, the light source drive unit 5 reduces the luminance of the light source 6 as low as possible until the left image and the right image to be written into the liquid crystal panels 8 are completely rewritten. On the other hand, when each of the left image and the right images is completely written completely, the light source drive unit 5 increases the luminance of the light source 6 as high as possible by the instruction of the control unit 2.

At this time, the light source drive unit 5 controls light source current supplied to the light source 6 by allowing images projected on the screen 13 to be synchronized with the liquid crystal shutters of the shutter glasses 21. For example, the light source drive unit 5 drives the light source 6 to reduce light source current as low as possible for the first 1/240 seconds when the right and left images start to be switched to thereby reduce the luminance of the light source 6. The liquid crystal shutters of both right and left lenses of the shutter glasses 21 are closed during the panel drive unit 7 rewrites images of the liquid crystal panels 8 so that the right image and the left image are not simultaneously viewed. As it is not necessary to display the images in the period during which both liquid crystal shutters of the shutter glasses 21 are closed, the user does not recognize the reduction of luminance even when the luminance of the light source 6 is reduced. At this time, the light source drive unit 5 can suppress power consumption of the light source 6 by reducing light source current as low as possible in a moment.

Then, the light source drive unit 5 increases light source current as high as possible in a stepwise manner for the next 1/240 seconds. In order to maximize the luminance of the light source 6, light source current should be maximized with respect to the time integral value. After that, light source current is reduced as low as possible when the liquid crystal shutters of right and left lenses are closed. In the period just before the opening of right and left lenses, light source current is not increased or intentionally reduced for avoiding the reduction in image quality due to effects of crosstalk.

The luminance of the light source 6 is reduced at the time of switching the left image and the right image by controlling light source current as described above, thereby suppressing crosstalk. Additionally, the luminance of the light source is increased as high as possible when both right and left images are completely rewritten, thereby projecting right and left images with higher luminance than related-art light sources. As the luminance of the light source is reduced as low as possible in the period of rewriting right and left images, which does hardly burden the light source and can extend a usable period of the light source 6. It is also possible to increase the luminance of right and left images while maintaining power consumption of the light source 6 to be constant over plural frame periods. Therefore, it is possible to maintain power consumption of the light source 6 to a degree equivalent to related-art light sources while increasing the luminance of 3D images.

### 2. Modification Example

In the case where right and left images are displayed on the liquid crystal panels 8 in time division in the same manner as described above, the present disclosure can be applied to a 3D display system in which different polarizations are respectively given to right and left images and an optical device having transmission polarization directions adapted to the polarizations is used for the shutter glasses. It is not always necessary to use the 3D image signal in which one frame is 60 P. It is also possible to increase the contrast between high luminance and low luminance. Additionally, light sources other than the UHP lamp having high light intensity such as a xenon lamp and a metal halide lamp can be used when power consumption of the light source 6 is constant.

The present disclosure is not limited to the above embodiment and it is obvious that other various application examples and modification examples can be applied within the scope not departing from the gist of the present disclosure described in the appended claims.

The present disclosure may be implemented as the following configurations.

(1) A display control circuit including

a device drive unit writing a left image and a right image alternately into a light modulation device in time division based on time-division display type stereoscopic image data including the left image for a left eye and the right image for a right eye,

a shutter glass drive unit driving opening and closing of liquid crystal shutters in the shutter glasses so that both liquid crystal shutters provided on lenses for the left eye and the right eye of the shutter glasses are closed in a rewrite period during which the left image and the right image written into the light modulation device overlap each other, and so that the liquid crystal shutter provided on the lens of the shutter glasses corresponding to the written image is opened in a period during which any of the left image and right image is independently written,

a light source drive unit increasing light source current to be supplied to a light source emitting light transmitted through the light modulation device and projected on a screen in the period during which any of the liquid crystal shutters is opened and reducing the light source current in the period during which both liquid crystal shutters are closed to thereby maintain the total sum of the light source current to be constant over plural cycles when an opening and closing period of the liquid crystal shutters is taken as one cycle, and

a control unit controlling the timing of opening and closing the liquid crystal shutters with respect to the shutter glass drive unit, controlling the timing of writing the left image and the right image with respect to the device drive unit and controlling the luminance level of the light source in the opening and closing period of the liquid crystal shutters with respect to the light source drive unit.

(2) The display control circuit described in the above (1),

in which the light source drive unit performs control so that light source current supplied to the light source is increased in a stepwise manner to an upper limit in accordance with a current function corresponding to an aperture function of the shutter glasses when the liquid crystal shutter is opened and reduces light source current supplied to the light source to a lower limit when the liquid crystal shutter is closed within a range between the upper limit and the lower limit of light source current allowed by the light source.

(3) The display control circuit described in the above (2),

in which the light source drive unit increases the luminance of the light source after a response period of the light modulation device passes at the time of rewriting the left image or the right image.

(4) The display control circuit described in the above (3),

in which the light source drive unit supplies the light source current to the light source so that a time integral value of the light source current is monotonically increased in the period during which the liquid crystal shutter is opened.

(5) The display control circuit described in the above (4),

in which the light source drive unit suppresses the increase of the light source current supplied to the light source just before the shutter glass drive unit opens the liquid crystal shutter as well as just after the shutter glass drive unit closes the liquid crystal shutter.

(6) The display control circuit described in the above (5),

in which the aperture function of the shutter glasses is defined as constant multiplication of the current function.

(7) The display control circuit described in the above (5),

in which the light modulation device is a transmissive or reflective liquid crystal panel.

(8) The display control circuit described in the above (5),

in which a shutter drive signal driving the liquid crystal shutters of the shutter glasses transmitted by the shutter glass drive unit is transmitted by wire or wireless.

(9) A projector apparatus including

a light modulation device into which a left image and a right image are alternately written in time division based on time-division display type stereoscopic image data including the left image for a left eye and the right image for a right eye,

a light source emitting light transmitted through the light modulation device and projected on a screen,

a device drive unit writing the left image and the right image into the light modulation device,

a lens magnifying the left image or the right image formed by light emitted from the light source and transmitted through the light modulation device with a given magnification,

a shutter glass drive unit driving opening and closing of liquid crystal shutters in the shutter glasses so that both liquid crystal shutters provided on lenses for the left eye and the right eye of the shutter glasses are closed in a rewrite period during which the left image and the right image written into the light modulation device overlap each other, and so that the liquid crystal shutter provided on the lens of the shutter glasses corresponding to the written image is opened in a period during which any of the left image and right image is independently written,

a light source drive unit increasing light source current to be supplied to the light source emitting light transmitted through the light modulation device in the period during which any of the liquid crystal shutters is opened and reducing the light source current in the period during which both liquid crystal shutters are closed to thereby maintain the total sum of the light source current to be constant over plural cycles when an opening and closing period of the liquid crystal shutters is taken as one cycle, and

a control unit controlling the timing of opening and closing the liquid crystal shutters with respect to the shutter glass drive unit, controlling the timing of writing the left image and the right image with respect to the device drive unit and controlling the luminance level of the light source in the opening and closing period of the liquid crystal shutters with respect to the light source drive unit.

The present disclosure contains subject matter related to that disclosed in Japanese Priority Patent Application JP 2011-145304 filed in the Japan Patent Office on Jun. 30, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display control circuit comprising:
a device drive unit writing a left image and a right image alternately into a light modulation device in time division based on time-division display type stereoscopic image data including the left image for a left eye and the right image for a right eye;
a shutter glass drive unit driving opening and closing of liquid crystal shutters in the shutter glasses so that both liquid crystal shutters provided on lenses for the left eye and the right eye of the shutter glasses are closed in a rewrite period during which the left image and the right image written into the light modulation device overlap each other, and so that the liquid crystal shutter provided on the lens of the shutter glasses corresponding to the written image is opened in a period during which any of the left image and right image is independently written;
a light source drive unit increasing light source current to be supplied to a light source emitting light transmitted through the light modulation device and projected on a screen in the period during which any of the liquid crystal shutters is opened and reducing the light source current in the period during which both liquid crystal shutters are closed to thereby maintain the total sum of the light source current to be constant over plural cycles when an opening and closing period of the liquid crystal shutters is taken as one cycle; and
a control unit controlling the timing of opening and closing the liquid crystal shutters with respect to the shutter glass drive unit, controlling the timing of writing the left image and the right image with respect to the device drive unit and controlling the luminance level of the light source in the opening and closing period of the liquid crystal shutters with respect to the light source drive unit.

2. The display control circuit according to claim 1,
wherein the light source drive unit performs control so that light source current supplied to the light source is increased in a stepwise manner to an upper limit in accordance with a current function corresponding to an aperture function of the shutter glasses when the liquid crystal shutter is opened and reduces light source current supplied to the light source to a lower limit when the liquid crystal shutter is closed within a range between the upper limit and the lower limit of light source current allowed by the light source.

3. The display control circuit according to claim 2,
wherein the light source drive unit increases the luminance of the light source after a response period of the light modulation device passes at the time of rewriting the left image or the right image.

4. The display control circuit according to claim 3,
wherein the light source drive unit supplies the light source current to the light source so that a time integral value of the light source current is monotonically increased in the period during which the liquid crystal shutter is opened.

5. The display control circuit according to claim 4,
wherein the light source drive unit suppresses the increase of the light source current supplied to the light source just before the shutter glass drive unit opens the liquid crystal shutter as well as just after the shutter glass drive unit closes the liquid crystal shutter.

6. The display control circuit according to claim 5,
wherein the aperture function of the shutter glasses is defined as constant multiplication of the current function.

7. The display control circuit according to claim 5,
wherein the light modulation device is a transmissive or reflective liquid crystal panel.

8. The display control circuit according to claim 5,
wherein a shutter drive signal driving the liquid crystal shutters of the shutter glasses transmitted by the shutter glass drive unit is transmitted by wire or wireless.

9. A projector apparatus comprising:
a light modulation device into which a left image and a right image are alternately written in time division based on time-division display type stereoscopic image data including the left image for a left eye and the right image for a right eye;
a light source emitting light transmitted through the light modulation device and projected on a screen;
a device drive unit writing the left image and the right image into the light modulation device;
a lens magnifying the left image or the right image formed by light emitted from the light source and transmitted through the light modulation device with a given magnification;
a shutter glass drive unit driving opening and closing of liquid crystal shutters in the shutter glasses so that both liquid crystal shutters provided on lenses for the left eye and the right eye of the shutter glasses are closed in a rewrite period during which the left image and the right image written into the light modulation device overlap each other, and so that the liquid crystal shutter provided on the lens of the shutter glasses corresponding to the written image is opened in a period during which any of the left image and right image is independently written;
a light source drive unit increasing light source current to be supplied to the light source emitting light transmitted through the light modulation device in the period during which any of the liquid crystal shutters is opened and reducing the light source current in the period during which both liquid crystal shutters are closed to thereby maintain the total sum of the light source current to be constant over plural cycles when an opening and closing period of the liquid crystal shutters is taken as one cycle; and
a control unit controlling the timing of opening and closing the liquid crystal shutters with respect to the shutter glass drive unit, controlling the timing of writing the left image and the right image with respect to the device drive unit and controlling the luminance level of the light source in the opening and closing period of the liquid crystal shutters with respect to the light source drive unit.
